(19) United States
(12) Patent Application Publication
(10) Pub. No.: US 2011/0055117 A1
(43) Pub. Date: Mar. 3, 2011

(54) METHOD FOR OPTIMIZING BUSINESS SUCCESS USING A PERFORMANCE CULTURE MATURITY MODEL

(75) Inventor: Howard Dresner, Nashua, NH (US)

(73) Assignee: Dresner Advisory Services LLC, Nashua, NH (US)

(21) Appl. No.: 12/868,797

(22) Filed: Aug. 26, 2010

Related U.S. Application Data
(60) Provisional application No. 61/238,879, filed on Sep. 1, 2009.

(51) Int. Cl. G06Q 90/00

(52) U.S. Cl. 705/500

(57) ABSTRACT

A method improves the success of a business or other organization by objectively evaluating its culture and implementing strategies for improvement thereof. Evaluation can be by an organization member or an outside consultant. The evaluation is according to four progressively desirable achievement levels applicable to each of six categories of culture as defined by a “Performance-directed Culture Maturity Model” (PDC-MM). Embodiments include monitoring the progress of the implemented improvement strategies by periodic re-evaluation the culture according to the PDC-MM model. The six categories are: “alignment with mission,” “transparency and accountability,” “action on insights,” “conflict resolution,” “common trust in data,” and “availability and currency of information.” The four achievement levels are “chaos reigns,” “departmental optimization,” “performance directed culture emerging,” and “performance-directed culture realized.” Improvement strategies can include enhancing organizational transparency, clearly communicating a comprehensive organizational mission, distributing authority and accountability among organizational divisions, and encouraging broad-based support for change.

### RELATED APPLICATIONS

This application claims the benefit of U.S. Provisional Applications No. 61/238,879, filed Sep. 1, 2009, which is incorporated herein by reference in its entirety for all purposes.

### COPYRIGHT NOTICE

Portions of the disclosure of this patent document contain material that is subject to copyright protection. The copyright owner has no objection to the facsimile reproduction by anyone of the patent document or the patent disclosure, as it appears in a published Patent and Trademark Office patent file or record, but otherwise reserves all copyrights whatsoever.

### FIELD OF THE INVENTION

The invention relates to methods for improving the success of a business, and more particularly to methods for implementing and monitoring business improvements based on evaluating a business culture according to a plurality of categories.

### BACKGROUND OF THE INVENTION

Every business has a management system, which consists of people, processes and technologies. For a business to function optimally, these elements must be aligned and optimized for performance, so as to empower people to make decisions and take action on their own, define processes for increasingly decentralized organizational structures, and use technology to support people and processes day-to-day while providing a platform for long-term business growth.

However, before an organization can implement an optimized and efficient management system, it must first create a culture that values performance, transparency, and accountability. In other words, people trump processes and technology every time.

Intuitively, this is well known. Anecdotal experiences abound wherein a technology initiative was scrapped or stalled because an important group of people didn't buy in: senior management offered lukewarm support, managers felt that they had not been consulted enough in the design of the system, or the system was so complex that end users could not use it.

This does not mean that technology is not important. It is—but as an enabler of people, and not the other way around.

Slowly, over the past few decades, this point of view has become conventional wisdom in management expert circles. In a 2008 report on Toyota, world-renowned for its ability to make large-scale operational performance improvements stick, McKinsey noted that many companies overlook up to half of the potential benefits of such efforts because they either underestimate the level of senior management involvement required, or the potential of employee “mindsets” to undermine them, or both. This implies that a business can have the best technology in the world, and yet derive only marginal benefit therefrom if the culture of the business is counterproductive. Nevertheless, enterprises continue to invest in new technology without ensuring that a culture which is conducive to its success exists—leading to wasted resources and failure.

What is needed, therefore, is a method for objectively characterizing the culture of a business, evaluating the culture so as to develop strategies for improvement, and then monitoring the success of any implemented improvement strategies.

### SUMMARY OF THE INVENTION

A method is claimed for improving the success of a business or other organization by improving its culture. The claimed method objectively characterizes the culture of the organization according to six defined categories and four achievement levels applicable to the categories. The method then develops strategies for improving the culture according to any of the categories in which the culture is deficient. In some embodiments, the method monitors the progress of the implemented strategies by periodically re-evaluating the culture according to the six categories and four achievement levels.

The present invention evaluates an organization using a “Performance-directed Culture Maturity Model” (PDC-MM) which characterizes an organization as having achieved one of four progressively desirable achievement levels in each of six distinct culture categories. This evaluation serves to identify the areas in the culture of the organization that are most in need of improvement, and provides a basis upon which targeted strategies can be devised and implemented so as to reach more desirable achievement levels in categories where the business culture is deficient.

Depending on the results of the PDC-MM evaluation, strategies for organization improvement can include enhancement of organizational transparency, clear communication of a comprehensive mission, distribution of authority and accountability among departments, and encouragement of broad-based support for change.

Strategies for enhancing organization transparency can include improving business intelligence systems, widening data access, strengthening data literacy, and increasing confidence in available business data.

Strategies for clearly communicating a comprehensive mission can include drafting or improving an organization mission statement, aggressively communicating the mission statement throughout the organization, encouraging discussion of the mission statement and its applicability to various segments of the organization, and creating a feedback loop to ensure that the mission and strategy remain relevant.

The ability to monitor and ensure alignment with the mission, strategy, goals, and objectives of the organization can be enhanced through the establishment and use of measurement systems, based on organizational data which may be used to determine individual and group performance.

Distribution of authority and accountability can include setting clear goals for departments, providing departmental managers with authority sufficient to implement the goals, and holding the departmental managers accountable for achievement of the goals.

Encouragement of broad-based support for change can include involving organization personnel in the planning and implementation process, coaching personnel as changes are implemented, and replacing personnel who remain unreceptive to change.

In some embodiments, once appropriate improvement strategies have been implemented, the claimed performance-directed culture maturity model is reapplied on a periodic basis so as to monitor the progress of the implemented strategies.

Tangible results of the claimed method can include improved profitability, improved market share, increased employee satisfaction, and/or growth of the organization.

One general aspect of the present invention is a method for improving the success of an organization. The method includes evaluating cooperative activity within the organization pertaining to a first category of alignment with an overall organizational mission, so as to assign to the first category an achievement level selected from a group of achievement levels consisting of substantially no cooperation, cooperation mainly within departmental groups, moderate cooperation between the departmental groups, and full cooperation between the departmental groups.

The method further includes evaluating cooperative activity within the organization pertaining to a second category of transparency and accountability, so as to assign to the second category one of the group of achievement levels.

The method further includes evaluating cooperative activity within the organization pertaining to a third category of sharing of insights and acting thereupon, so as to assign to the third category one of the group of achievement levels

The method further includes evaluating cooperative activity within the organization pertaining to a fourth category of identifying and resolving conflicts, so as to assign to the fourth category one of the group of achievement levels.

The method further includes evaluating cooperative activity within the organization pertaining to a fifth category of confidence in and reliance upon provided data, so as to assign to the fifth category one of the group of achievement levels.

The method further includes evaluating cooperative activity within the organization pertaining to a sixth category of availability and currency of information, so as to assign to the sixth category one of the group of achievement levels.

The method further includes identifying at least one of the evaluated categories as an improvable category, selecting at least one improvement strategy intended to enhance cooperative activity within the identified at least one improvable category, and implementing the selected at least one improvement category.

Embodiments of the method further include, after implementing the at least one improvement strategy, determining a degree of improvement by reevaluating cooperative activity pertaining to the at least one improvable category according to the group of achievement levels. Some of these embodiments of the method further include, after reevaluating the at least one improvable category, repeating the steps of selecting and implementing. Other of these embodiments further include reevaluating cooperative activity pertaining to all of the categories according to the group of achievement levels. And some of these embodiments further include, after reevaluating the cooperative activity pertaining to all of the categories, repeating the steps of selecting and implementing.

Various embodiments further include repeating all of the steps of the method at periodic intervals so as to monitor and continue improvement of the organization. In some embodiments identifying at least one of the evaluated categories as an improvable category includes noting and considering dates upon which achievement levels assigned to the categories were attained.

In some embodiment, at least one of the improvement strategies is directed toward clearly communicating a comprehensive and relevant organizational mission throughout the organization, enhancing transparency within the organization, distributing authority and accountability among organizational divisions, and/or encouraging broad-based support for change.

In certain embodiments, at least one of the improvement strategies includes encouraging the enforcement of accountability and driving alignment with organizational mission, strategy, goals and objectives through the use of data and a metric-based discipline and systems. In some of these embodiments the metric-based discipline and systems include at least one of business intelligence and performance management.

Various embodiments further include periodically reevaluating the organization according to the categories and the achievement levels so as to monitor progress of the organization in attaining higher achievement categories.

In some embodiments the evaluating steps are implemented by at least one evaluator who is not a member of the organization. In other embodiments the evaluating steps are implemented by at least one evaluator who is a member of the organization. Some of these embodiments further include providing supporting materials to the at least one evaluator, the supporting materials being adapted for assisting the at least one evaluator in evaluating cooperative activity within the organization pertaining to the six categories, and in assigning to each of the categories one of the group of four achievement levels. And in some of these embodiments the supporting materials include a book, a workbook, an audible presentation, and/or a visual presentation.

In various embodiments evaluating cooperative activity within the organization pertaining to the first category of alignment with an overall organizational mission includes determining a quantifiable goal for the organization. In some of these embodiments the quantifiable goal includes increased profits, increased market share, increased stock share price, increased sales volume, increased return on investment, increased customer satisfaction, improved industry rating, increased benefit to beneficiaries, increased membership, and/or increased member satisfaction. Other of these embodiments further include, after implementing the at least one improvement strategy, determining progress toward attaining the quantifiable goal.

Another general aspect of the present invention is an apparatus for improving the success of an organization, the apparatus including an item of supporting material, the item of supporting material being adapted for assisting an evaluator to do at least one of the following:

evaluate cooperative activity within the organization pertaining to a first category of alignment with an overall organizational mission, so as to assign to the first category an achievement level selected from a group of achievement levels consisting of substantially no cooperation, cooperation mainly within departmental groups, moderate cooperation between the departmental groups, and full cooperation between the departmental groups;

evaluate cooperative activity within the organization pertaining to a second category of transparency and accountability, so as to assign to the second category one of the group of achievement levels;

evaluate cooperative activity within the organization pertaining to a third category of sharing of insights and acting thereupon, so as to assign to the third category one of the group of achievement levels;

evaluate cooperative activity within the organization pertaining to a fourth category of identifying and resolving conflicts, so as to assign to the fourth category one of the group of achievement levels;

evaluate cooperative activity within the organization pertaining to a fifth category of confidence in and reliance upon provided data, so as to assign to the fifth category one of the group of achievement levels;

evaluate cooperative activity within the organization pertaining to a sixth category of availability and currency of information, so as to assign to the sixth category one of the group of achievement levels;

identify at least one of the evaluated categories as an improvable category;

select at least one improvement strategy intended to enhance cooperative activity within the identified at least one improvable category; and

implement the selected at least one improvement category.

In some embodiments, the item of supporting material is a book, a workbook, an audible presentation, and/or a visual presentation.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow diagram which illustrates the basic steps of the present invention;

FIG. 2A is a table which illustrates the six categories and four achievement levels of the Performance-directed Culture Maturity Model (PDC-MM) of the present invention;

FIG. 2B is a table similar to FIG. 1 to which dates of achievement have been added pertaining to a specific example of implementation of the PDC-MM model;

FIG. 3A illustrates application of the first category of the PDC-MM model to a hypothetical company which is at the “chaos reigns” achievement level;

FIG. 3B illustrates subsequent application of the first category of the PDC-MM model to the hypothetical company of FIG. 3A after it has achieved the “departmental optimization” achievement level;

FIG. 3C illustrates subsequent application of the first category of the PDC-MM model to the hypothetical company of FIG. 3A after it has achieved the “Performance Directed culture realized” achievement level;

FIG. 4 is table in which the six categories of FIG. 1 have been organized into three primary groups;

FIG. 5 is a flow chart which illustrates improvement strategies that can be implemented in embodiments of the present invention; and

FIG. 6 is a flow chart of an embodiment of the invention.

### DETAILED DESCRIPTION

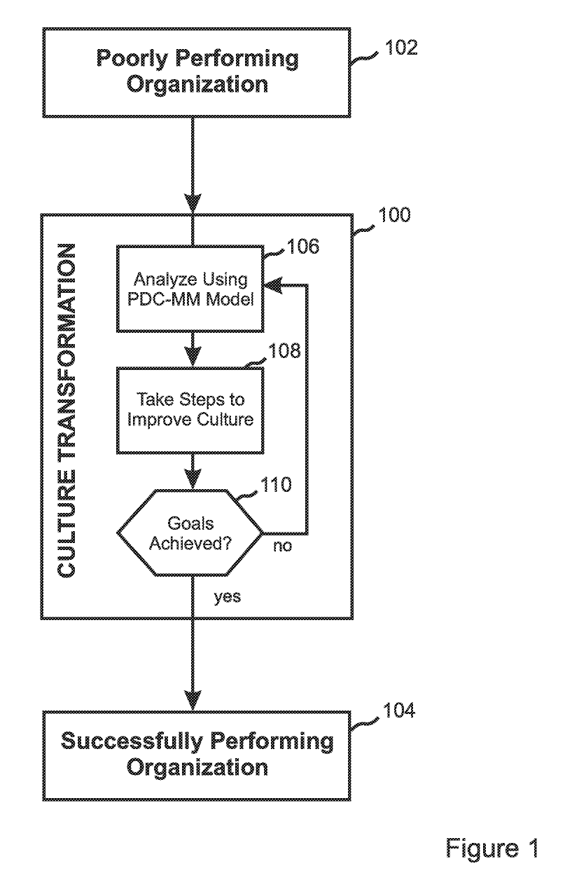

With reference to FIG. 1A, the present invention is a method 100 for transforming a business or other organization from a poorly performing organization 102 into a successfully performing organization 104. The claimed method 100 uncovers and addresses the internal, underlying causes for poor performance by analyzing 106 patterns of behavior within the organization, especially degrees of cooperation and adherence to common goals. These patterns of behavior are generally referred to herein as the “culture” of the organization. Steps are then taken 108 to improve the culture. If the goals of the organization have not yet been met 110, the method can be repeated as needed.

The context for application of the invention is an underperforming organization, according to whatever performance criteria the controlling stakeholders have selected as indicative of how well the organization is fulfilling the goals and objectives of the stakeholders. Performance criteria may include objective parameters such as market share, sales volume, net profit, return on investment, share value, etc; and/or more subjective parameters such as a measure of client satisfaction, employee satisfaction, or industry rating or other forms of public perception of the value and success of the organization. The basic assumption is that improvements in performance can be achieved by altering the internal behavior or “culture” of the organization,

According to embodiments of the present invention, the first step in transforming an organization is to analyze its culture 106 by comparing it to a specific and detailed organizational culture model, herein referred to as the “Performance-directed Culture Maturity Model,” or “PDC-MM.” The comparison identifies and highlights specific areas of deficiency within the organization's culture, and serves to suggest concrete steps that can be implemented so as to improve the culture, and consequently the performance of the organization. The second step in transforming the organization is to implement the concrete steps 108 suggested by the PDC-MM analysis 106. In some embodiments, if the goals have not yet been satisfactorily achieved 110, application of the PDC-MM analysis 106 can be repeated so as to monitor the transformation and implement additional concrete steps as needed.

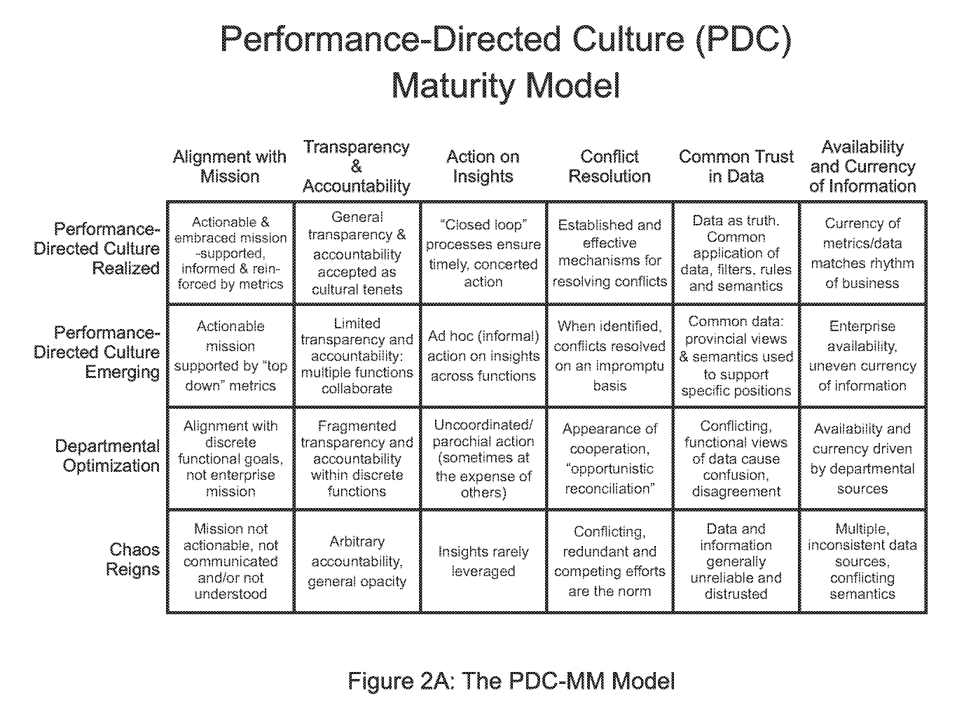

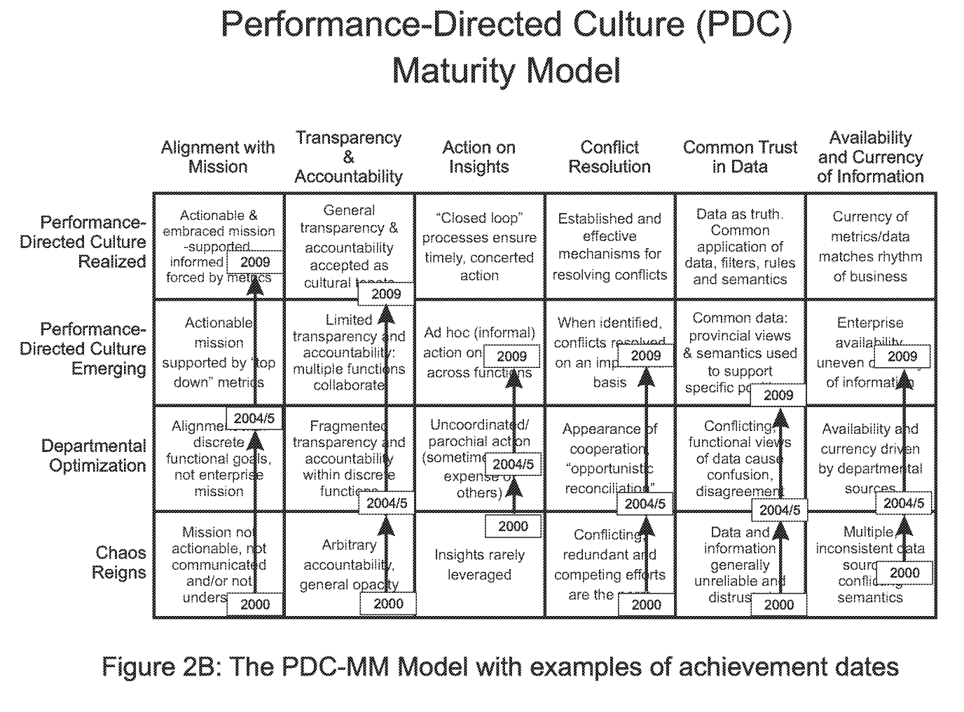

FIG. 2A presents a chart which summarizes the Performance-directed Culture Maturity Model (PDC-MM) of the present invention. As shown along the top of FIG. 2A, the PDC-MM model includes six specific “Performance-directed Culture” or “PDC” categories. The model also includes four progressively desirable levels of achievement or “maturity levels” that can be assigned in each of the categories, as is shown down the left side of the table in FIG. 1B. In various embodiments, the comparison and evaluation is performed by one or more members of the organization, or by an outside consultant who is not a member of the organization and who has no vested interests or biases, financial or otherwise, regarding the outcome of the analysis or the concrete steps employed to transform the organization.

Even the least mature organization would hopefully not be at the absolute lowest level in each category. So, almost without exception, every enterprise will be at different levels of maturity across the six categories. This is normal and is part of the process of assessing and improving the maturity of a business or of any other organization.

In some embodiments, as shown in FIG. 2B, the PDC-MM evaluation is further enhanced by estimating the dates on which various achievement levels were reached, and plotting these dates on the chart of the PDC-MM model. For example, in FIG. 2B three achievement dates are indicated for each of the six categories, with the mid-point representing the moment when significant (and positive) changes began to emerge. Not only is this approach useful to help better understand current strengths, weaknesses, accomplishments, and areas for improvement, it also provides an understanding of the chronology of key events, and associated cause and effect relationships.

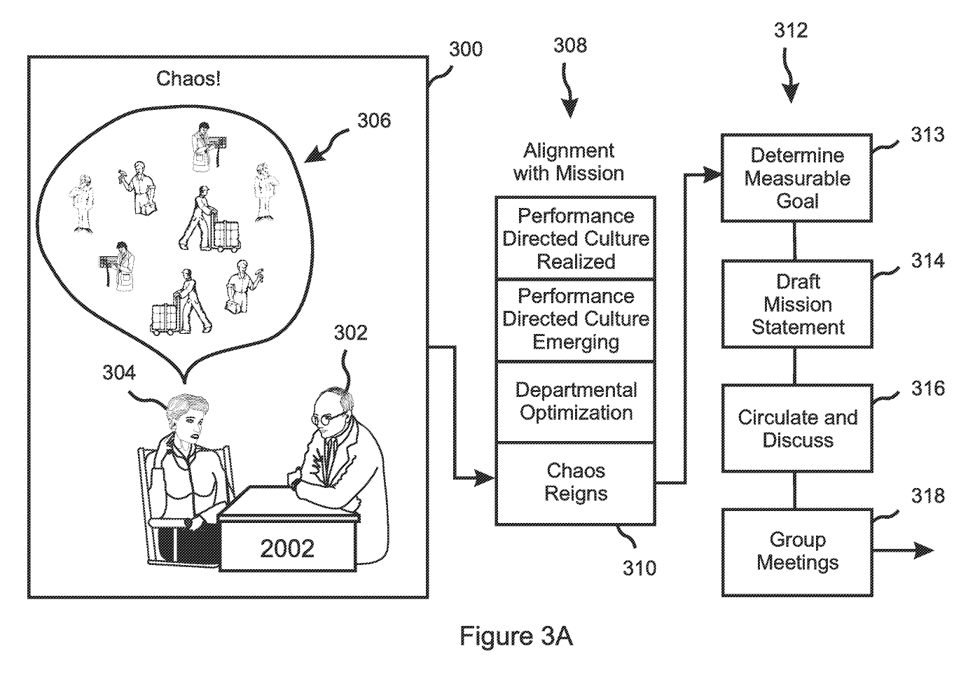

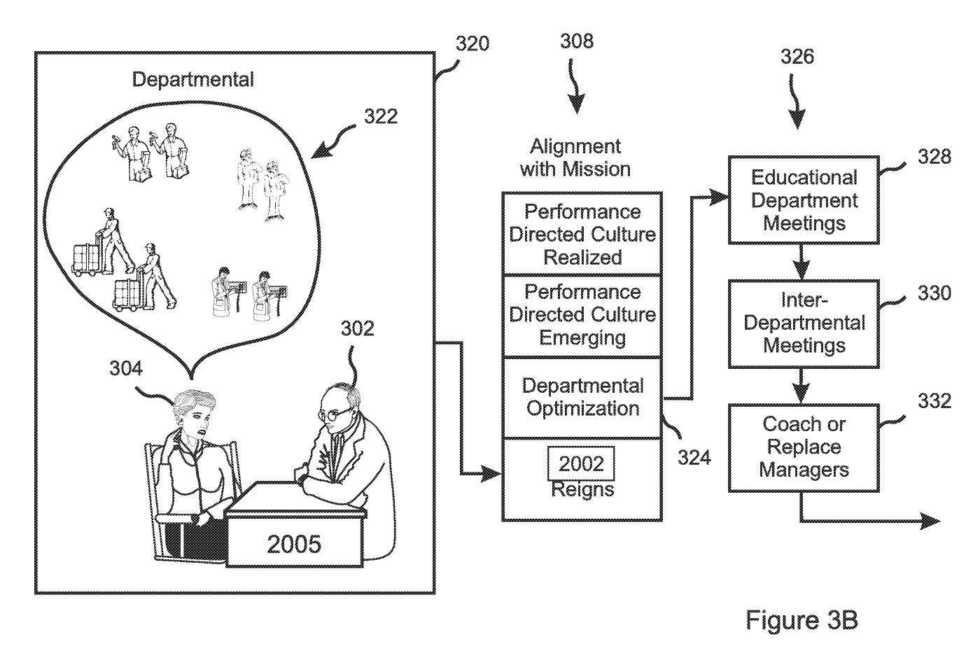

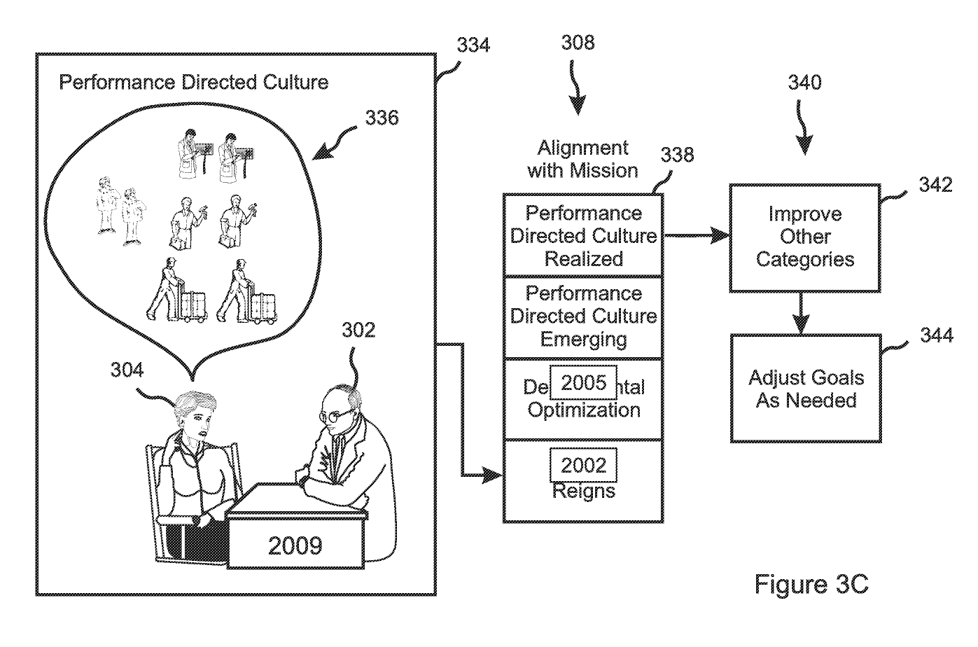

A typical embodiment of the present invention applied to a hypothetical company is illustrated in FIG. 3A. Application of the method begins 300 in this example with an outside consultant 302 being called in to evaluate a company in the year 2002. The outside consultant is well trained and experienced in the application of the present invention, and has no preconceived biases or interests in the company, financial or otherwise. Being independent of the organization, he is able to evaluate the organization impartially, based on his knowledge of the method of the present invention, and on his experience working with other organizations. He is also in a strong position to suggest fresh approaches, since he has made no contribution to developing or implementing the current approaches.

In other embodiments, the method of the present invention is implemented by personnel within the organization. In some of these approaches, a book, a workbook, an audible presentation, a visual presentation, and/or other materials relating to the present invention are obtained by the organization so as to assist in training at least some of the members to effectively apply the method. This approach requires that at least one member of the organization take time to study the supplied materials and becomes familiar with the method of the present invention. While an unbiased analysis of an organization by its own members may be difficult to achieve, and may require significant effort by a plurality of the members, this approach can nevertheless ensure that at least some members of the organization will become well acquainted with the present method, will be fully invested in its application and success, and will gain deep insights from the analysis that it provides, and the transformation that results.

In the embodiment of FIG. 3A, the company has been in business since 2000, but as of 2002 it still has no clear mission statement. The consultant begins by asking several managers 304 what the mission of the company is, and receives a variety of different answers. More than one non-management employee replies, only half in jest, that the mission of the company is “to make money.” The company is not, in fact, making money, and most of the members of the organization 306 are reacting by striving mainly to preserve their jobs. Management is implementing frequent reorganizations, aimed mainly at providing an appearance of “doing something,” while the rank-and-file employees 306 work mainly to ensure that blame is directed at someone other than themselves. As indicated in FIG. 3A, the consultant concludes, according to the PDC-MM model 308, that with regard to the first category of “Alignment with Mission” there is essentially no cooperative activity within the company, and accordingly ranks the company culture at the lowest, or “chaos reigns” level 310 for that category.

In the hypothetical example of FIG. 3A, the next step in the method is to implement several concrete steps for improvement 312 that are suggested by the analysis of the company according to the PDC-MM analysis 308. The consultant has some frank discussions with the chief executive officer and his support team so as to determine the actual goals of the company. Several candidate goals are considered and compared, including maximizing profitability, increasing market share, growing the size of the company, and increasing the share price of the company's stock. Initially, there is some uncertainty as to what the actual goal should be, but eventually it is decided that increasing market share should be the focus of the company at this time. Since market share can be quantified, this provides a concrete metric by which to measure the progress of the organization.

Management is then tasked to draft a clear, specific mission statement for the organization 314. Drafts of the mission statement are circulated and discussed with middle management and with the rank-and-file employees 316, so as to obtain their input and also increase their support for the final mission statement. And group meetings are held 318 in which various departments discussed how their group can enhance the success of the mission.

With reference to FIG. 3B, by early 2005 the market share of the company has grown, and it is clear that the company has made some progress in reaching its goal. However, more progress is needed, and so the company decides to apply the method of the present invention a second time. The outside consultant 302 is asked to perform a follow-up PDC-MM analysis 320 so as to determine the progress of the company's “culture,” due to the steps 312 that were implemented in 2002. The consultant finds that a strong sense of mission has emerged at the departmental level, with each department 322 striving as a group to further the company mission. Sales is striving to increase company sales, Engineering is working together to make a better product, Service is striving to increase customer satisfaction, and so forth. This undoubtedly explains the growth in market share that the company has achieved.

However, the consultant 302 also finds that the various departments 322 within the company are viewing each other with suspicion, and in many cases believe that other departments 322 are inhibiting them from achieving “their” goals. Engineering feels that Sales is asking for impossible new features. Sales believes that Engineering is unwilling to design products that customers will actually purchase. Service is convinced that Engineering is recklessly introducing too many new parts and subassemblies, rather than re-using sub-assemblies and thereby simplifying spare parts support, and so forth. To make matters worse, management 304 has implemented a program of competition between groups, in the belief that such competition is “healthy.” In many cases management 304 assigns the same task to more than one department 322, with the understanding that the “winner” will be rewarded at the expense of the “loser.”

According to the embodiment of FIG. 3B, with regard to the first category of “Alignment with Mission,” the consultant 302 realizes that each of the various departments has essentially reinterpreted the company mission statement in a way that applies only to their department. Sales' mission is to sell, no matter what they have to promise to customers. Engineering's mission is to design new products that will work reliably and will include new features, but the choice of new features is dictated mainly by the availability of new technologies, with little regard for whether customers actually want these new features. Service's mission is to repair the products as efficiently as possible, and so they resent the introduction of any new products, which only make their “job” harder. Accordingly, the consultant 302 ranks the company culture in the second, or “Departmental Optimization” level 324, recognizing that cooperative behavior is well established within departments, but is virtually non-existent between departments.

In the embodiment of FIG. 3B, the method continues with implementation of several concrete steps for improvement 326 that are suggested by the analysis of the company according to the PDC-MM 308. A series of educational meetings 328 is held to teach employees in general, and department managers in particular, how the work of each department contributes to the success of the company as a whole. The meetings are initially held on a departmental level 328, and then on an inter-departmental level 330. Employees learn that Sales really does need new products designed to meet customer expectations, but that Sales should not promise features to customers that Engineering cannot deliver. Engineering learns that they should introduce new features, but should introduce serviceable products that focus on what customers really want, even if it means forgoing some exciting new technologies, and so forth.

As these educational meetings progress, specific managers are singled out as being resistant to change, and are targeted with additional coaching 332. In some cases, the additional coaching works. In other cases, a manger is asked to leave, and is replaced by a new manager who is more compatible with a performance-directed culture.

By 2009 the company's market share has clearly improved. Suspecting that this is due to further improvement in the company's performance-directed culture, the management decides to apply the method of the present invention a third time, as illustrated in FIG. 3C. A third evaluation 334 of the company is performed by the outside consultant 302 in 2009. The evaluation reveals that, for the most part, the departments 336 have learned to value each other's contributions, and to work together for the success of the organization as a whole, and not just of the individual departments.

The consultant 302 therefore ranks the company culture in the fourth, or “Performance Directed Culture Realized” level 336 for the first category column of “alignment with mission.” The method then continues 340, by application of the PDC-MM analysis to other categories 342 that may need improvement. Having established a performance-directed culture, the company is empowered to achieve whatever goals it sets for itself. For example, if the company adjusts its goals 344 such that growth of profits becomes the new goal, the full resources of the company can be focused and redirected as needed, now that all of the employees and departments are cooperating and working together.

For clarity and simplicity, the embodiments of FIGS. 3A through 3C have been illustrated and discussed only with reference to the first category 308 of the PDC-MM model, “Alignment with Mission.” In fact, for each application of the present invention the company would be evaluated according to each of the six categories of the PDC-MM, as presented in FIG. 2A and FIG. 2B, and in general concrete steps for improvement would be implemented for each category.

The following sections describe the four achievement levels and six categories of the PDC-MM model in detail.

### Four Levels of Maturity

The four levels of culture achievement or “maturity,” as shown in the left column of FIGS. 2A and 2B, are described in the following sections.

### Level One—Chaos Reigns

The first and lowest level of achievement is labeled in FIGS. 2A and 2B as “Chaos Reigns”. At this level, little progress or achievement towards a Performance Directed culture (“PDC”) is evident. Fragmentation and disorganization are the norm. This is not a sustainable state, since companies at this level tend to be at serious risk of collapse. This level could also be called “dysfunction,” or simply PDC “Hell.” Assuming that there was an organization “stuck” at this level, across all categories, it would be a very unpleasant concern to work with—as an employee, partner or customer.

### Level Two—Departmental Optimization

The second level of achievement is indicated in FIGS. 2A and 2B as “Departmental Optimization.” At this level, departments and functions are playing for themselves. While this sort of organization seems to function well enough to survive, cooperation and collaboration are virtually unheard of. Management is either ineffective or uninterested in forging alignment with its mission or fostering cooperation across departments and functions.

Oddly enough, this is the most common level for organizations (to some degree) and it raises an important point about human nature. Humans have always favored working in small groups of people with similar backgrounds, outlooks and goals. Anthropologists refer to these groups as tribes. Historically, tribes were small bands of related kinfolk who worked together for basic survival. These sorts of “tribes” continue in modern society and in business. For example, corporate departments and functions act as tribes of a sort. With similar backgrounds and experiences, outlooks and goals, members of each department or function work together to protect their “tribe” from outside threats.

Hence there is typically a Finance tribe, an HR tribe, a Sales tribe and so on, with each of these groups either covertly competing against the others or acting in direct conflict. While this sort of behavior may be a good match for our natural human programming, it's not particularly helpful for the greater enterprise. But it does explain why so many organizations get stuck at the second level.

### Level Three—PDC Emerging

As indicated in FIGS. 2A and 2B, at the level of “PDC Emerging,” an organization has started to see the benefits of working across departmental barriers and is more focused upon a common mission. Cross-functional sharing and cooperation tend to be impromptu and opportunistic. Two or more functions may start to work together for mutual benefit. Word of mouth of their success starts to spread. A virtuous cycle is starting to emerge as the benefits of a PDC become obvious, with management providing the needed support and encouragement.

This level can be considered a “point of no return,” from which an organization will inevitably achieve a fully mature, performance-directed culture, given sufficient time to do so. It should be noted that it is difficult to even approach this level of achievement without a profound (and positive) change on the part of corporate leadership. This sort of change is usually associated with a physical change of management, in favor of more enlightened leadership, or with a major event, which serves as a “wake up call” for existing management.

### Level Four—PDC Realized

By the level of “PDC Realized,” as indicated in FIGS. 2A and 2B, performance improvement has permeated the very fabric of the culture. Processes center around transparency and accountability. Individuals are rewarded for sharing, cooperating and supporting the mission of the enterprise. The enterprise thinks, strategizes, plans, analyzes, and executes as a single organism. In Maslow's world this would be the equivalent of “self-actualization”.

While it is extremely rare for an organization to achieve the fourth level in all categories, it is not uncommon for an organization to achieve this level in one or more categories. In general, it is the continual, ongoing pursuit of PDC that counts.

It should come as no surprise that organizations that have achieved a good measure of Performance-directed Culture (levels three and four) are great companies to work for and do business with. These organizations are positive and purposeful, with motivated employees and delighted customers. Their employees, customers, management and ownership are indeed lucky to have such a forward-thinking and visionary organization in their midst.

### Six Performance Directed Culture Categories

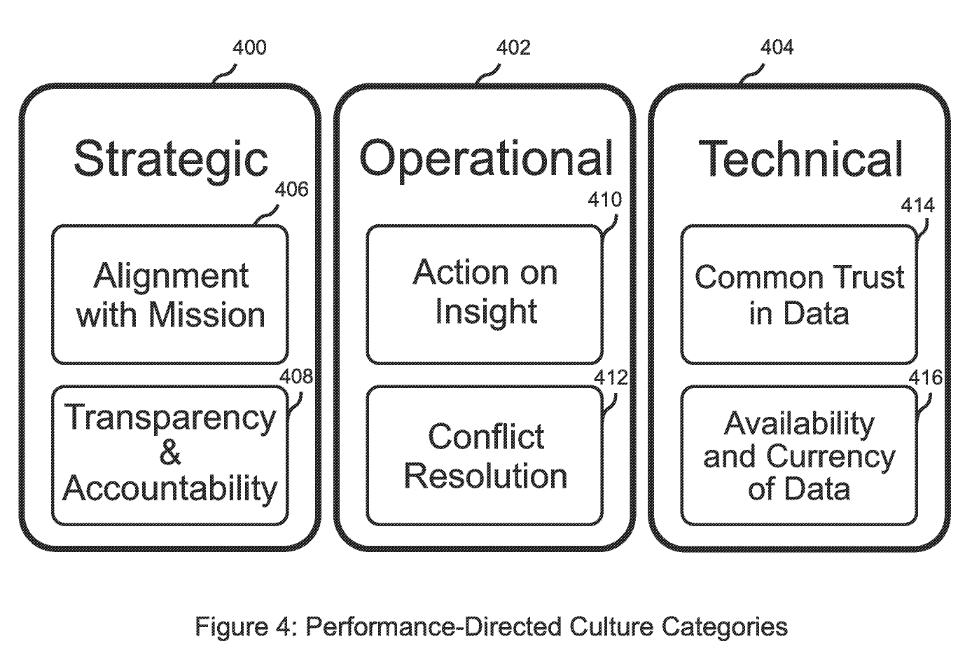

Each of the six PDC categories illustrated across the tops of FIGS. 2A and 2B fall into one of three general categories, as shown in FIG. 4. These three general categories are “Strategic” 400, “Operational” 402, and “Technical” 404. Within the Strategic general category are the two categories of “Alignment with Mission” 406 and “Transparency and Accountability” 408. These strategic categories must be initiated and driven by the most senior of management, typically C-level executives. Within the operational general category are “Action on Insight” 410 and “Conflict Resolution” 412. Operational categories are categories that all members of an organization have a role in driving on a day-to-day basis.

And, finally, within the Technical general category are: “Trust in Data” 414 and “Availability and Currency of Data” 416. The technical categories are managed by a partnership between business management and the IT function or other technical resources.

### Strategic Categories

These categories are driven and controlled by the most senior levels of management. In other words, no other group or level within the organization can raise the organization up to the achievement level of a Performance-directed Culture for these two categories: Alignment with Mission and Transparency & Accountability. Additionally, these two categories will help elevate all other areas of PDC achievement. It's also worth noting that without achieving PDC in these categories, a true PDC is not attainable.

Alignment with Mission: So as to consider alignment with a mission, it is first necessary to have a viable mission statement. Of course, that begs the question: “What makes for a good mission statement?” It can be said that the best mission statements are the simple ones that communicate what an organization is really about and that everyone can understand and rally around.

Many of the mission statements for the Fortune 500 are not well conceived. Some are much too long, and others give little or no indication of what the company actually does. All too many of them talk about “shareholder value” or being “the leader,” serving their “community” or being the “best.” Many of them even reference “profitability”—which (hopefully) is one outcome of a good mission, but is not the actual mission itself. These mission statements are not ones that people in an organization can easily relate to or align with.

In contrast, others companies have created simple, meaningful and actionable mission statements. For example, CVS' mission statement is: “We will be the easiest pharmacy retailer for customers to use”. It's clear and concise, and everyone ought to know how to align with this. Cleveland Clinic's mission statement is “Patient First.” Once again, it's clear and concise, and easy to align with.

At least one organization was even found to have a mission statement that was considered confidential. To be effective, a mission statement clearly must be shared openly and communicated throughout the organization. The best mission statement is of no use if it's a secret.

Alignment with Mission Level One (chaos reigns): This is the lowest stage of achievement for alignment with the mission. Here the mission is either not viable, not actionable, not communicated, and/or not understood. The example of the “secret” mission statement fits nicely into this category. Also in this category are those mission statements that try to associate the enterprise with whatever is “hot” at the moment, or that will create a positive image for the public, but does not really indicate the identity of the organization or what it actually does. So, to be effective and to foster a PDC, mission statements can't be “extra-curricular,” for example, corporate social responsibility (CSR), green and so on. In other words, a corporate mission statement must describe what the company really does and truly stands for.

Alignment with Mission Level Two (Departmental Organization): While there might be an enterprise mission, at this level it is often overlooked in favor of alignment with discrete functional goals within departments. Whether intentional or unintentional, explicit or implicit, each department has developed its own mission and drives departmental alignment within it. While the departments may pay lip service to a corporate mission, the reality is quite different. Discrete departmental missions may overlap with peer department missions, often with their management consciously working to expand their mission and “conquer” other departments' areas of responsibility and authority for their own parochial gain.

Alignment with Mission Level Three (PDC Emerging): At this level a proper and actionable mission has been defined and communicated top down. Companies at this level know who they are, know their strengths and weaknesses and have a strategy and a drive to improve. Through strong leadership, employees (and other stakeholders) have embraced and internalized the mission. There is a clear understanding, at a personal, departmental, divisional and enterprise level, about what it means to support and align with this mission. Appropriate plans and top-down metrics have been created and pushed downward to support and reinforce alignment. However, at this level organizational observations and experience don't reliably inform and influence strategy in a bi-directional way. This creates the potential for placing the vision and strategy out of sync with the ever-changing operational business environment.

Alignment with Mission Level Four (PDC Realized): As with level three above, there's a solid mission statement with alignment (and ownership) throughout the organization and across all stakeholders. However, the major difference with Level Four is that observations, insights and ideas from below filter back up to management to inform, influence and mold the strategy—better ensuring support for the mission—as the external (and internal) environment changes.

Transparency and Accountability: The members of an organization frequently indicate support for transparency and accountability, yet these goals can remain very hard to achieve. This is because an indication of support for transparency and accountability often means that each member of the organization wants everyone to be transparent with them while they remain opaque to others, and they want others to be held accountable without being held accountable themselves. In contrast, real transparency means that everyone openly and freely shares information with others, including information about their own performance. In a transparent and accountable organization, metrics have a clear cause-and-effect relationship, and everyone has the information and tools to control their own performance—in harmony with others, not at their expense. Accordingly, organization members hold themselves, and each other, accountable for performance—individually and collectively.

Transparency and Accountability Level One (Chaos Reigns): At this stage of achievement, there is no real transparency. Knowledge is power, and few are willing to relinquish that power—even if the enterprise will benefit. Typically, the only way to know what's really going on is to have a personal information network, with people “in the know” willing to help.

Accountability is not based on real or tangible plans and is not aligned with a larger, enterprise (or even departmental) mission. Instead it is dependent on local or immediate management and their ideals, biases, and, sometimes, private agendas. As a result, what people are held accountable for will change. So, goals and objectives (and measures) agreed upon at the beginning of the year may not be used to measure people at the end of the year.

While this may sound insidious, it can be quite innocent. For example, at the beginning of the year, an employee and his or her manager may agree on goals, which may include things like customer satisfaction, quality, efficiency, revenue, and profitability. However, due to the opacity of the organization, at the end of the year, measurement might be limited to whatever reliable information is available—perhaps only revenue. Of course, over time, employees get wise to this and only focus on those metrics they are certain will be used to measure them.

Transparency and Accountability Level Two (Departmental Organization): At this level, it is not uncommon to find two departments within an enterprise that share information and are held accountable only within their function, by immediate management and peers, but are closed and opaque to everyone else in the enterprise. Typically, a departmental mission is the driving force behind this sort of transparency and accountability. Any mandatory sharing of information or shared accountability is done in the narrowest way possible to maintain secrecy and protect territorial boundaries. And, in many cases, a department will skew information to better position themselves or obstruct other (competitive) functions. Additionally, this lack of transparency and accountability is often used to shift the blame for failure.

Transparency and Accountability Level Three (PDC Emerging): At this stage, limited transparency and accountability begins to emerge, with multiple functions beginning to collaborate. While this may start opportunistically—with cooperating groups leveraging each other for self-serving purposes—the benefits of sharing, openness and collaboration start to become apparent. Information sharing expands and eventually leads to shared metrics across functions. However, at this point, there is still no overarching corporate initiative, with much of the organization still operating at Level Two.

Transparency and Accountability Level Four (PDC Realized): At this stage, general transparency and accountability are accepted and embraced as cultural tenets, and are part of the corporate fabric. The open sharing of information, insights and ideas is encouraged and rewarded. Shared metrics are the norm, with users finding new ways to improve their collective performance and that of the enterprise.

### Operational Categories

The categories in this group are unique, in that management cannot control or direct them. This is the realm of every organization member. The rank-and-file employees and stakeholders determine how and when to execute against these categories. Hence, success or failure is in their hands. Because of their operational nature, they represent continuous processes, which require constant attention and diligence to avoid regression to a previous stage.

Action on Insights: Of course, the old adage that “information is power” comes to mind. Similarly, it can be said that often, in a business or other organization, insight is power.

The Wikipedia definition of insight is: “the power of acute observation and deduction, penetration, discernment, perception called intellection or noesis.” Insight can be understood as meaningful information, with context, that enables a person to develop perspective and understanding, making the underlying information both relevant and actionable. And, it needn't come from an information system. Insight can come from any source. And in this context “actionable” indicates the ability to effect change as a result of leveraging the insight for the benefit of an individual and/or an organization.

Action on Insights Level One (Chaos Reigns): At this level there simply isn't much insight to act on. Individuals rely upon intuition and instincts to make decisions, and have a limited understanding of the issues facing them. The resulting decision-making process is little better than guessing. In the event that a real insight is stumbled upon, it may be leveraged for some personal advantage. But, more than likely, its potential benefit will never be realized.

Action on Insights Level Two (Departmental Organization): At this level insights are leveraged and perspective developed in alignment with a departmental mission. These insights and the resulting departmental actions may take place at the expense of a peer department. A perfect example is when two product/business groups identify a market opportunity and both develop products/services to address it—effectively competing in the market with each other.

Action on Insights Level Three (PDC Emerging): At this level insights are shared across two or more departments and actions may also be coordinated, but on a somewhat opportunistic basis. However, this is the beginning of PDC-like behavior, where more concerted action is becoming more common. Still, enterprise-wide processes for acting on insights have not yet emerged.

Action on Insights Level Four PDC Realized): At this level enterprise processes have been established to help drive a coordinated and concerted response to insights. For example, if Marketing learns something valuable about a target market, it may translate that insight into a new campaign. The plan surrounding this campaign will include collaboration with Sales, Manufacturing, Finance, Distribution, Human Resources and so on. It's a holistic plan that is vetted and executed in unison. Changes during execution are shared and the entire organization, and its shared plan, evolves until it hits its stride. In this scenario, nobody is blind-sided, and there are few surprises. Surprises that do emerge are dealt with quickly. And, early successes are quickly amplified before the opportunity passes.

### Conflict Resolution

Sadly, conflict is a part of human nature. We all come with different experiences, perspectives, goals and objectives. However, conflict can be a positive force. By vetting multiple opinions in an open and constructive fashion, a more complete and thoughtful solution to a problem can be created, with greater inclusion and camaraderie. Or, it can be negative—with opinions held secretly and passive-aggressive behavior as the norm. Conflicting perspectives, semantics and outlooks inevitably manifest themselves as competing projects, products, or functions.

Conflict Resolution Level One (Chaos reigns): In organizations at this level, dissenting opinions, although certainly present, are not openly aired. Management is unwilling to challenge itself to resolve differing perspectives and attitudes. Instead, it allows them to fester—manifesting themselves as contradictions within the organization and the business.

Some organizations allow, or even encourage, the creation of competing efforts, under the guise that it will be healthy for the organization. The result, however, is that employees are often pitted against each other, with the knowledge that those who lose the competition might also lose their jobs and livelihoods. This can lead to an environment where conflict is the norm. In fact, it can be all-out warfare. In the final analysis, these organizations would fare better if they fostered a culture of cooperation and conflict resolution. So, while an all-out “cut throat” environment may be rare, there is a bit of it in many organizations.

Conflict Resolution Level Two (Departmental Organization): A this level management weighs in on some important issues and drives the resolution of some conflicts (or tries to). Sometimes it succeeds, but often it merely creates the illusion of reconciliation. Conflicting views are not typically aired. Private agendas still abound—with only limited conflicts grudgingly resolved.

Conflict Resolution Level Three (PDC Emerging): Management has begun to create an environment where it is safe and encouraged to exchange differing points of view. When identified, conflicts get resolved on an impromptu basis. In this scenario, people are less likely to purposely create conflict. Nevertheless, there are no consistent, enterprise-wide mechanisms for resolving conflict. Instead, individuals, when encountering potentially conflicting efforts, must develop their own process for resolution. Accordingly, the quality of the outcome will vary from case to case.

Conflict Resolution Level Four (PDC Realized): At this level, dissenting voices are encouraged and included as vital in the decision-making processes of the organization. For major undertakings, management requires that they be vetted to ensure that they don't conflict with other efforts. In this way, conflict is avoided before major investments are made. Of course, conflict cannot be avoided entirely. Instead, in this scenario, the organization has established a best-practice set of protocols for identifying and resolving conflict in a way that is both positive and most beneficial for the enterprise. Rather than members of a “losing” group facing possible forfeiture of their jobs, in this situation competing efforts might be combined—leveraging the strengths of each to create a single initiative which is stronger than either would have been independently.

### Technology Categories

Although a Performance-directed Culture is not driven by technology, certain aspects of technology are important enablers. In particular, the availability, currency and trustworthiness of data are absolutely critical for a PDC to be created and sustained in the long term and on an enterprise scale. So, in acknowledgement of this reality, two categories are included that focus upon information technology—specifically data. Although data warehousing and Business Intelligence technologies play a role here, they must be employed in alignment the other PDC categories: strategy and operations.

Common Trust in Data: For a Performance-directed Culture (PDC) to thrive, it must be supported by reliable information whose veracity is assured and widely accepted. This information serves as the substrate for which all decisions are framed and made in a PDC. Developing and delivering a trusted data environment is extremely difficult work—not because of technology—but because of the reluctance of people to have faith in and rely upon it. It can take many years to build such a reputation, and only an instant to destroy it.

Common Trust in Data Level One (Chaos Reigns): In this scenario, data is more likely to misinform than inform. Instead, people rely on other, more informal, sources of “information,” or they rely upon “experience” or “intuition” (better known as “guessing”) or anecdotal information from colleagues or various publications.

Common Trust in Data Level Two (Departmental Organization): In this scenario, data is available and (generally) trusted within specific functions, for example Finance. However, differing views of data, as supported by various “stove-piped” systems, cannot be easily reconciled. Management frustration with this status quo may lead to an IT-driven data warehouse project—without resolving the underlying business conditions for irreconcilable data views.

Common Trust in Data Level Three (PDC Emerging): In this scenario a common and reliable source of data is in place, and its veracity is generally accepted. However, some will apply varying filters and semantics to better position themselves, their departments, or their projects. As a PDC emerges, this sort of behavior will be rejected as unacceptable and will dissipate.

Common Trust in Data Level Four (PDC Realized): At this point, the organization has a trusted information source that is not disputed or manipulated for parochial purposes. Managers arrive to meetings collectively briefed on relevant information, and come prepared to address current problems. Debate about the data is at a minimum.

### Availability and Currency of Information

The availability and currency of data contribute greatly to developing trust in the data. Here, availability means completeness of the information (as many sources as needed) to build a useful business perspective. It also means that the information must be accessible whenever the business needs it.

In this context, currency means that the freshness and periodicity of information must match the needs of the business. For example, the business may require certain metrics or key performance indicators (KPIs) to be reported as a weekly indicator, but updated daily.

Availability and Currency of Information Level One (Chaos Reigns): At this level the information sources are in chaos. Reports generated by operational systems provide a limited view of reality, and offer a poor “rearview mirror” analysis of the business. Users are forced to piece data together by themselves—often causing the use and proliferation of spreadsheet technology and, what might be called “micro-marts” of data. The resulting spreadsheet models are shared, modified, and shared again. This situation can be compared to the children's game of “telephone,” where a first child whispers a phrase to the next child—and so on—until the end where the final phrase bears little resemblance to the original one.

Availability and Currency of Information Level Two (Departmental Organization): At this level, departmental systems provide a good and consistent view of the function's operations and business. However, each department and function has its own discrete systems and outlook on the world, making it difficult to reconcile them for a more complete enterprise view. When required to provide a more complete view, by management, tremendous amounts of energy must be expended—only to deliver a flawed perspective, much too late.

Availability and Currency of Information Level Three (PDC Emerging): At this level, the enterprise has excellent availability of information, with good quality and completeness of information. However, the currency of the information may not be consistently aligned with the needs of the business.

Availability and Currency of Information Level Four (PDC Realized): Currency of metrics and data matches the rhythm of the business. At this level the information is as complete as possible, quality and integrity of data are outstanding, and the periodicity and currency are a perfect match to the business requirements.

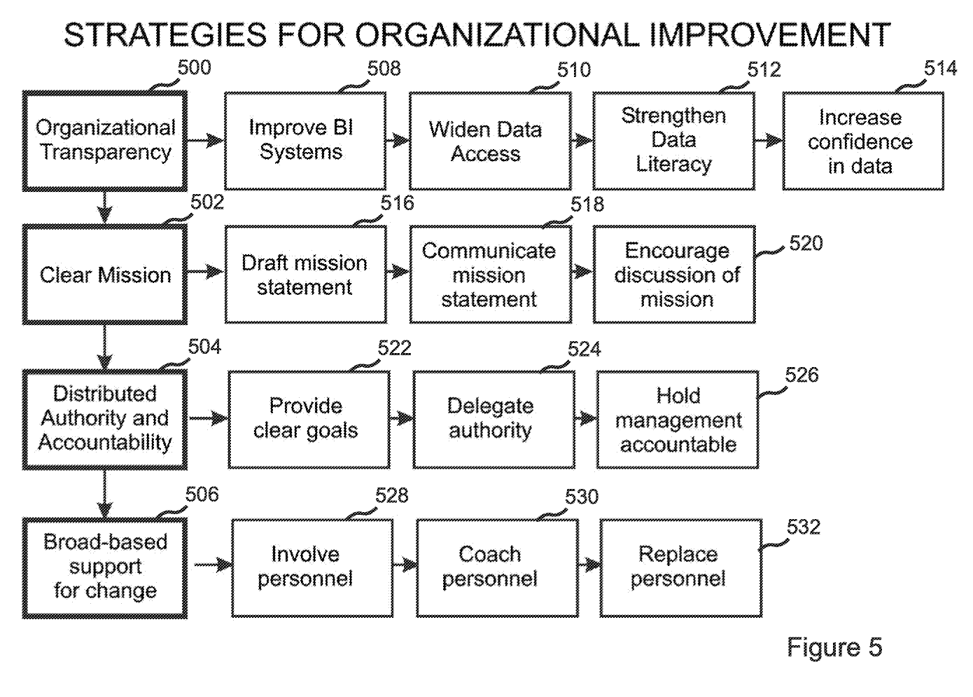

Once the PDC-MM analysis described above has been applied to a business or other organization, the claimed method continues by using the results of the analysis to devise and implement strategies to achieve higher performance levels in categories where the organization is currently deficient. FIG. 5 illustrates some primary improvement strategies and specific elements of those strategies that can be implemented in embodiments of the present invention.

Primary strategies for organization improvement can include enhancement of organizational transparency 500, clear communication of a comprehensive mission 502, distribution of authority and accountability among departments 506, and encouragement of broad-based support for change 508.

Strategies for enhancing organization transparency 500 can include improving business intelligence systems 508, widening data access 510, strengthening data literacy 512, and increasing confidence in available business data 514. Software tools such as “Business Intelligence” or “Enterprise Performance Management” systems can provide data that is vital for management to understand the nature of the organization, including fundamental metrics as well as more subtle information such as customer types and market segments being addressed. Good data systems that are widely available and generally trusted, and that most or all managers can easily and confidently use, can also provide insights into the overall operations of the organization, highlighting the activities of each group, and elucidating how the various group functions coordinate (or fail to coordinate) so as to achieve the goals of the organization as a whole.

Strategies for clearly communicating a comprehensive mission 502 can include drafting or clarifying an organization mission statement 516, aggressively communicating the mission statement throughout the organization 518, and encouraging discussion of the mission statement and its applicability to various segments of the organization 520. Once the organization has a transparency that allows departments to effectively work together, it is vital that everyone be “on the same page” regarding the goals of the organization, and how those goals apply to each department. This provides consensus as to the mission of the organization, so that the departments not only CAN work together, but WILL work together.

Distribution of authority and accountability 504 can include setting clear goals for departments 522, providing to departmental managers authority sufficient to implement the goals 524, and holding the departmental managers accountable for achievement of the goals 526. Cultural maturity requires that managers of groups or departments strive in unison to achieve the goals of the organization as a whole. If a departmental manager is held accountable for achieving goals, but is not given the authority needed to achieve the goals, then the manager will mainly strive to find excuses and to avoid blame. On the other hand, if the manager is given responsibility without being held accountable, then the manager may not have sufficient incentive to seek achievement of the assigned goals, and may instead pursue other goals of his or her own choosing.

Encouragement of broad based support for change 506 can include involving organization personnel in the planning and implementation process 528, coaching personnel as changes are implemented 530, and replacing personnel who remain unreceptive to change 532. Involvement in the planning and implementation of new strategies is a powerful tool for obtaining “buy-in” from personnel. In addition, careful explanation as to how new procedures and policies will enhance the organization and ultimately be beneficial to all members, and thorough instruction and coaching of personnel as to how to implement new strategies, will often achieve full cooperation. In those cases where these strategies do not work (and this applies to ALL levels of the organization), it may be necessary to replace unreceptive personnel.

The details of these improvement strategies will vary depending on the nature of the organization and on the specific categories where improvement is sought. However, once the results of the PDC-MM analysis are available, the development of strategies for improving the culture of the organization will generally be straightforward according to methods well known in the art.

In various embodiments, once strategies for improvement have been implemented, the PDC-MM analysis is repeated, in some embodiments on a periodic basis, so as to monitor the progress of the improvement strategies, and so as to suggest new areas of improvement once the most egregious deficiencies have been addressed.

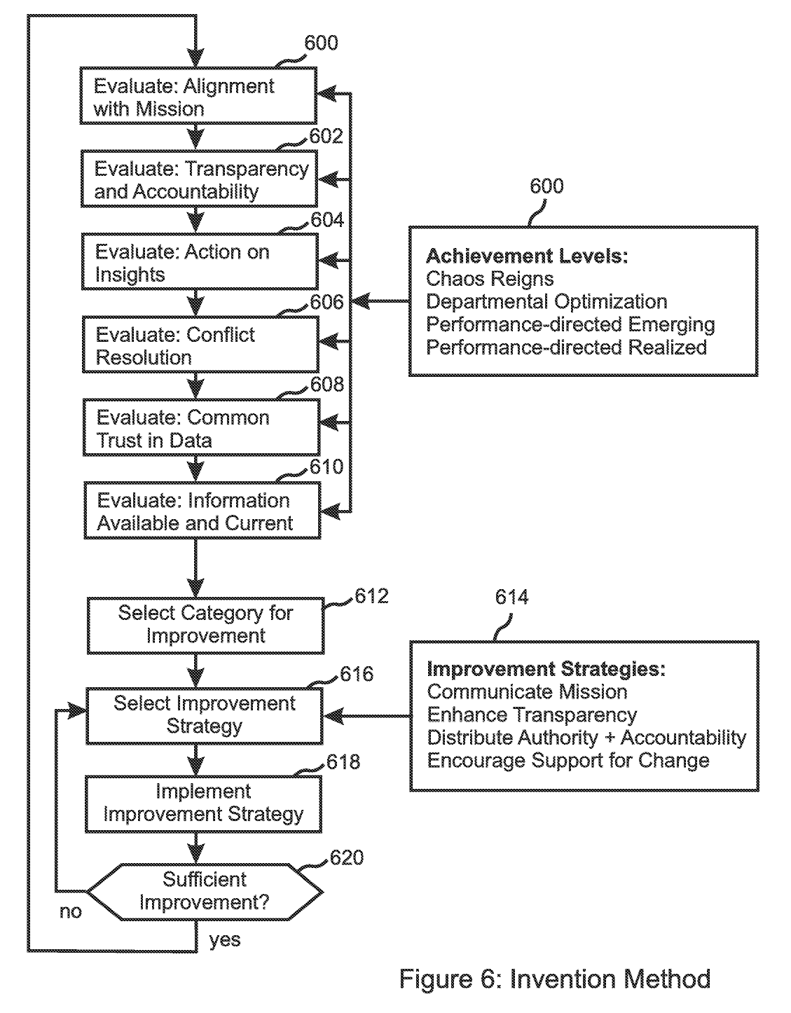

FIG. 6 is a flow diagram that illustrates an embodiment of the invention. After evaluating the organization according to each of the six PDC-MM categories and four PDC-MM achievement levels 600-610, at least one of the categories is selected as being in need of improvement 612. At least one improvement strategy 614 is then selected 616 and implemented 618. After giving the improvement strategies a chance to work, the category is re-evaluated 620 according to the four PDC-MM achievement levels. If sufficient improvement is not found, the strategies are reviewed and possibly revised or replaced. This cycle repeats until sufficient improvement is seen, at which point the entire process is repeated so as to select new categories in need of improvement.

Of course, the ultimate test of the value of the invention is in the change in performance of the organization as a whole with respect to the external environment in which it functions. At such time as the internal behavior of the organization is seen to have been affected to a measurable degree by the processes of the invention, and allowing such time as may be needed for the changed internal behavior to affect overall organizational performance with respect to the external environment, performance can again be measured according to the same criteria by which it was initially determined to be under-performing. In this manner, the application of the invention results in the transformation of an under performing organization into a better performing organization.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for improving the success of an organization, the method comprising:
evaluating cooperative activity within the organization pertaining to a first category of alignment with an overall organizational mission, so as to assign to the first category an achievement level selected from a group of achievement levels consisting of substantially no cooperation, cooperation mainly within departmental groups, moderate cooperation between the departmental groups, and full cooperation between the departmental groups;
evaluating cooperative activity within the organization pertaining to a second category of transparency and accountability, so as to assign to the second category one of the group of achievement levels;
evaluating cooperative activity within the organization pertaining to a third category of sharing of insights and acting thereupon, so as to assign to the third category one of the group of achievement levels;
evaluating cooperative activity within the organization pertaining to a fourth category of identifying and resolving conflicts, so as to assign to the fourth category one of the group of achievement levels;
evaluating cooperative activity within the organization pertaining to a fifth category of confidence in and reliance upon provided data, so as to assign to the fifth category one of the group of achievement levels;
evaluating cooperative activity within the organization pertaining to a sixth category of availability and currency of information, so as to assign to the sixth category one of the group of achievement levels;
identifying at least one of the evaluated categories as an improvable category;
selecting at least one improvement strategy intended to enhance cooperative activity within the identified at least one improvable category; and
implementing the selected at least one improvement category.

2. The method of claim 1, further comprising, after implementing the at least one improvement strategy, determining a degree of improvement by reevaluating cooperative activity pertaining to the at least one improvable category according to the group of achievement levels.

3. The method of claim 2, further comprising, after reevaluating the at least one improvable category, repeating the steps of selecting and implementing.

4. The method of claim 2, further comprising reevaluating cooperative activity pertaining to all of the categories according to the group of achievement levels.

5. The method of claim 4, further comprising, after reevaluating the cooperative activity pertaining to all of the categories, repeating the steps of selecting and implementing.

6. The method of claim 1, further comprising repeating all of the steps of the method at periodic intervals so as to monitor and continue improvement of the organization.

7. The method of claim 1, wherein identifying at least one of the evaluated categories as an improvable category includes noting and considering dates upon which achievement levels assigned to the categories were attained.

8. The method of claim 1, wherein at least one of the improvement strategies is directed toward at least one of:
clearly communicating a comprehensive and relevant organizational mission throughout the organization;
enhancing transparency within the organization;
distributing authority and accountability among organizational divisions; and
encouraging broad-based support for change.

9. The method of claim 1, wherein at least one of the improvement strategies includes encouraging the enforcement of accountability and driving alignment with organizational mission, strategy, goals and objectives through the use of data and a metric-based discipline and systems.

10. The method of claim 9, wherein the metric-based discipline and systems include at least one of business intelligence and performance management.

11. The method according to claim 1, further comprising periodically reevaluating the organization according to the categories and the achievement levels so as to monitor progress of the organization in attaining higher achievement categories.

12. The method of claim 1, wherein the evaluating steps are implemented by at least one evaluator who is not a member of the organization.

13. The method of claim 1, wherein the evaluating steps are implemented by at least one evaluator who is a member of the organization.

14. The method of claim 13, further comprising providing supporting materials to the at least one evaluator, the supporting materials being adapted for assisting the at least one evaluator in evaluating cooperative activity within the organization pertaining to the six categories, and in assigning to each of the categories one of the group of four achievement levels.

15. The method of claim 14, wherein the supporting materials include at least one of:
a book;
a workbook;
an audible presentation; and
a visual presentation.

16. The method of claim 1, wherein evaluating cooperative activity within the organization pertaining to the first category of alignment with an overall organizational mission includes determining a quantifiable goal for the organization.

17. The method of claim 16, wherein the quantifiable goal includes at least one of:
increased profits;
increased market share;
increased stock share price;
increased sales volume;
increased return on investment;
increased customer satisfaction;
improved industry rating;
increased benefit to beneficiaries;
increased membership; and
increased member satisfaction.

18. The method of claim 16, further comprising, after implementing the at least one improvement strategy, determining progress toward attaining the quantifiable goal.

19. An apparatus for improving the success of an organization, the apparatus comprising an item of supporting material, the item of supporting material being adapted for assisting an evaluator to at least one of:
evaluate cooperative activity within the organization pertaining to a first category of alignment with an overall organizational mission, so as to assign to the first category an achievement level selected from a group of achievement levels consisting of substantially no cooperation, cooperation mainly within departmental groups, moderate cooperation between the departmental groups, and full cooperation between the departmental groups;
evaluate cooperative activity within the organization pertaining to a second category of transparency and accountability, so as to assign to the second category one of the group of achievement levels;
evaluate cooperative activity within the organization pertaining to a third category of sharing of insights and acting thereupon, so as to assign to the third category one of the group of achievement levels;
evaluate cooperative activity within the organization pertaining to a fourth category of identifying and resolving conflicts, so as to assign to the fourth category one of the group of achievement levels;
evaluate cooperative activity within the organization pertaining to a fifth category of confidence in and reliance upon provided data, so as to assign to the fifth category one of the group of achievement levels;
evaluate cooperative activity within the organization pertaining to a sixth category of availability and currency of information, so as to assign to the sixth category one of the group of achievement levels;
identify at least one of the evaluated categories as an improvable category;
select at least one improvement strategy intended to enhance cooperative activity within the identified at least one improvable category; and
implementing the selected at least one improvement category.

20. The method of claim 19, wherein the item of supporting material is one of:
a book;
a workbook;
an audible presentation; and
a visual presentation.
